(19) United States
(12) Patent Application Publication
(10) Pub. No.: US 2025/0370290 A1
(43) Pub. Date: Dec. 4, 2025

(54) Display Device for Landscape and Portrait Usage a Portrait Optimized Positioning Device

(71) Applicant: Dell Products L.P., Round Rock, TX (US)

(72) Inventor: Guentaek Oh, Singapore (SG)

(21) Appl. No.: 18/731,543

(22) Filed: Jun. 3, 2024

(51) Int. Cl. G02F 1/1333; F21V 8/00

(52) U.S. Cl. CPC G02F 1/133322; G02B 6/0073; G02B 6/0088

(57) ABSTRACT

A display device which includes a display device optical component and a portrait mode optimization system. The portrait mode optimization system includes a portrait mode optimized positioning device positioned contiguous to the display device optical component, the portrait mode optimized positioning device being configured to perform a display device portrait mode optimization operation.

### BACKGROUND OF THE INVENTION

### Field of the Invention

The present invention relates to information handling systems. More specifically, embodiments of the invention relate to information handling system display devices.

### Description of the Related Art

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

### SUMMARY OF THE INVENTION

An information handling system display device which includes a panel design optimized for landscape and portrait orientations is disclosed.

More specifically, in one embodiment the invention relates to a portrait mode optimization system for a display device comprising: a portrait mode optimized positioning device positioned contiguous to a display device optical component, the portrait mode optimized positioning device being configured to perform a display device portrait mode optimization operation.

In another embodiment the invention relates to a display device comprising a display device optical component; and, a portrait mode optimization system, the portrait mode optimization system comprising a portrait mode optimized positioning device positioned contiguous to the display device optical component, the portrait mode optimized positioning device being configured to perform a display device portrait mode optimization operation.

In another embodiment the invention relates to a system comprising: a processor; a data bus coupled to the processor; and a display device, the display device comprising a display device optical component; and, a portrait mode optimization system, the portrait mode optimization system comprising a portrait mode optimized positioning device positioned contiguous to the display device optical component, the portrait mode optimized positioning device being configured to perform a display device portrait mode optimization operation.

### BRIEF DESCRIPTION OF THE DRAWINGS

The present invention may be better understood, and its numerous objects, features and advantages made apparent to those skilled in the art by referencing the accompanying drawings. The use of the same reference number throughout the several figures designates a like or similar element.

FIG. 1 shows a general illustration of components of an information handling system as implemented in the present disclosure.

FIG. 2 shows a block diagram of an information handling system configuration and fabrication environment.

FIGS. 3A and 3B, generally referred to as FIG. 3, show front views of a display device in a landscape orientation and a portrait orientation, respectively.

FIG. 4 shows a front view of a display device which includes a panel design optimized for operation in landscape and portrait orientations.

FIGS. 5A and 5B, generally referred to as FIG. 5, show views of section 5A when the display device is operating in a landscape orientation and a portrait orientation, respectively.

FIG. 6 shows a front view of a display device which includes a panel design optimized for operation in landscape and portrait orientations.

FIGS. 7A and 7B, generally referred to as FIG. 7, show views of section 7A when the display device is operating in a landscape orientation and a portrait orientation, respectively.

FIG. 8 shows a perspective view of a portion of a guide panel of a display device which is optimized for operation in landscape and portrait orientations.

### DETAILED DESCRIPTION

Certain aspects of the disclosure reflect an appreciation that many known information handling system display devices include a pivot function which enables the display device to function in a landscape mode of operation as well as a portrait mode of operation. Certain aspects of the disclosure reflect an appreciation that many known information handling system display devices can be mounted to a display device mounting device which includes an arm to which the display device is mounted. Certain aspects of the disclosure include an appreciation that many such display device mounting devices provide a pivot function which enables the display device to be mounted in a landscape mode of operation, a portrait mode of operation, or a combination thereof. Certain aspects of the disclosure include an appreciation that often users prefer a multi-monitor configuration which uses a plurality of monitors which are configured with a combination of a landscape mode of operation, a portrait mode of operation,

Certain aspects of the disclosure reflect an appreciation that many known information handling system display device panel designs are based on functioning in a landscape mode of operation and not a portrait mode of operation. Because of this, some known information handling system display devices can have front of screen (FOS) quality issues such as hot spot issues, bright line or dark line issues as well as other types of optical performance issues. For example, some known information handling system display devices present hot spot issues along a side edge of the display device when functioning in a portrait mode of operation (which would have been a bottom edge of the display device when functioning in a landscape mode of operation). For example, some known information handling system display devices present bright or dark line issues along a top edge of the display device when functioning in a portrait mode of operation (which would have been a side of the display device when functioning in a landscape mode of operation). Due to these quality issues, display device suppliers often cannot guarantee picture quality when the display device is functioning in a portrait mode of operation.

Certain aspects of the disclosure reflect an appreciation that many known information handling system display device panel designs include one or more display device optical components such as a display device light guide plate (LGP).

Certain aspects of the disclosure reflect an appreciation that in operation, display device optical components (such as the display device light guide plate) often expands under certain conditions such as high temperature conditions, high humidity conditions, or a combination thereof. Certain aspects of the disclosure reflect an appreciation that the display device optical components (such as the display device light guide plate) can have a coefficient of thermal expansion (COD) of about 160×10−6 m/(m° C.). Certain aspects of the disclosure reflect an appreciation that because of this thermal expansion, certain information handling system display device designs provide a gap between LGP and edges of a cover bottom of the display device. For example, a known 27″ display device may be designed with a 1.0 mm gap along each edge of the cover bottom of the display device.

Certain aspects of the disclosure reflect an appreciation that when operating in a portrait mode of operation, the LEDs of the display device can produce a lack of light uniformity which results in the hot spot issue. Certain aspects of the disclosure reflect an appreciation that to prevent a hot spot issue, a surface of the optical components of the information handling system display devices are often designed with a special dense light guide plate pattern (such as a repeating triangular dense pattern) between LED package have been applied on the LGP surface.

Certain aspects of the disclosure reflect an appreciation that when operating in a portrait mode of operation, the LGP drops to the downside of the cover bottom due to the designed thermal expansion gap. Certain aspects of the disclosure reflect an appreciation that when operating in a portrait mode of operation, attempts to address this LGP drop have included insertion of an elastomeric component (e.g., rubber) at each corner of the cover bottom. However, even with the addition of these components, the LGP drops due to compression of the elastomeric components. Additionally, certain aspects of the present disclosure include an appreciation that it can be difficult to correctly position the elastomeric components within the cover bottom during manufacture of the display device. Certain aspects of the disclosure reflect an appreciation that this LGP shift can cause misalignment between the display device LED patterns and the LGP patterns which result in the presence of the hot spot issue.

Accordingly, a system and method are disclosed for providing an information handling system display device with a display device portrait mode optimization system. In certain embodiments, the display device portrait mode optimization system performs a display device portrait mode optimization operation. In certain embodiments, the display device portrait mode optimization system implements portrait mode optimized positioning device. In certain embodiments, the portrait mode optimized positioning device includes a reversible guide panel structure. In certain embodiments, the portrait mode optimized positioning device includes a guide panel which includes an embedded bumper structure. Various aspects of the present disclosure include an appreciation that providing a portrait mode optimized positioning device enables removal of the elastomeric components which optimizes display device portrait mode performance. Various aspects of the present disclosure include an appreciation that removal of the elastomeric components saves cost, reduces display device assembly complexity and reduces the likelihood of quality issues associated with mis-assembled elastomeric components.

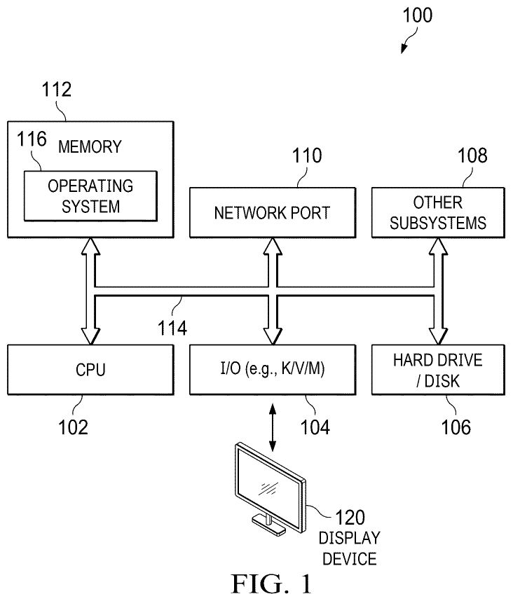

FIG. 1 is a generalized illustration of an information handling system 100 that can be used to implement the system and method of the present invention. The information handling system 100 includes a processor (e.g., central processor unit or “CPU”) 102, input/output (I/O) devices 104, such as a display, a keyboard, a mouse, a touchpad or touchscreen, and associated controllers, a hard drive or disk storage 106, and various other subsystems 108. In various embodiments, the information handling system 100 also includes network port 110 operable to connect to a network 140, which is likewise accessible by a service provider server 142. The information handling system 100 likewise includes system memory 112, which is interconnected to the foregoing via one or more buses 114. System memory 112 further comprises operating system (OS) 116. In various embodiments, the information handling system 100 is coupled with and communicates with a display device 120. In various embodiments, the information handling system is integrated with the display device to provide an all in one (AIO) type information handling system. In certain embodiments, the information handling system includes a portable information handling system which includes an integrated display device.

In certain embodiments, the display device 120 includes a display device portrait mode optimization system. In certain embodiments, the display device portrait mode optimization system performs a display device portrait mode optimization operation. As used herein, a display device portrait mode optimization operation broadly refers to any task, function, operation, procedure, or process performed, directly or indirectly, within an information handling system display device environment to configure, implement, operate, monitor, manage, maintain, or remediate an information handling system display device when the information handling system is operating in a portrait mode of operation.

In certain embodiments, the display device portrait mode optimization system implements portrait mode optimized positioning device. In certain embodiments, the portrait mode optimized positioning device includes a reversible guide panel structure. In certain embodiments, the portrait mode optimized positioning device includes a guide panel which includes an embedded bumper structure. Various aspects of the present disclosure include an appreciation that providing a portrait mode optimized positioning device enables removal of the elastomeric components which optimizes display device portrait mode performance. Various aspects of the present disclosure include an appreciation that removal of the elastomeric components saves cost, reduces display device assembly complexity and reduces the likelihood of quality issues associated with mis-assembled elastomeric components.

For purposes of this disclosure, an information handling system may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, or other purposes. For example, an information handling system may be a personal computer, a network storage device, or any other suitable device and may vary in size, shape, performance, functionality, and price. The information handling system may include random access memory (RAM), one or more processing resources such as a central processing unit (CPU) or hardware or software control logic, ROM, and/or other types of nonvolatile memory. Additional components of the information handling system may include one or more disk drives, one or more network ports for communicating with external devices as well as various input and output (I/O) devices, such as a keyboard, a mouse, and a video display. The information handling system may also include one or more buses operable to transmit communications between the various hardware components.

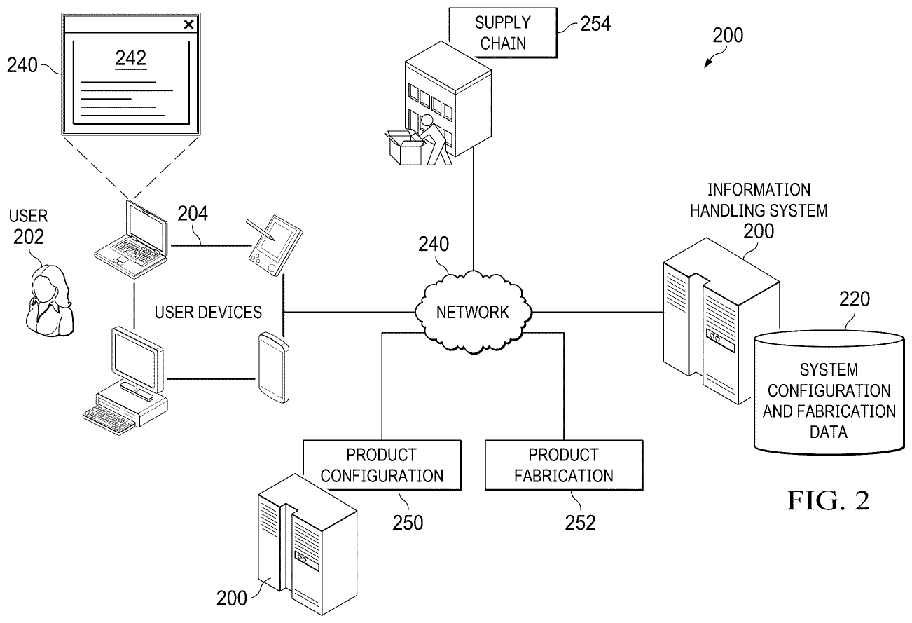

FIG. 2 is a block diagram of an information handling system configuration and fabrication environment 200 implemented in accordance with an embodiment of the invention. In certain embodiments, the information handling system configuration and fabrication environment 200 may include a repository of information handling system configuration and fabrication data 220. In certain embodiments, the repository of information handling system configuration and fabrication data 220 may be local or may be executed remotely.

In certain embodiments, the user device 204 is used to exchange information between the user 202 and a product configuration system 250, and a custom product fabrication system 250, through the use of a network 240. In certain embodiments, the network 240 may be a public network, such as a public internet protocol (IP) network, a physical private network, a wireless network, a virtual private network (VPN), or any combination thereof. Skilled practitioners of the art will recognize that many such embodiments are possible, and the foregoing is not intended to limit the spirit, scope or intent of the invention. As used herein, a user device 204 refers to an information handling system such as a personal computer, a laptop computer, a tablet computer, a personal digital assistant (PDA), a smart phone, a mobile telephone, or other device that is capable of communicating and processing data. In certain embodiments, the user device 204 may be configured to present a configuration and/or fabrication system user interface (UI) 240. In certain embodiments, the configuration and/or fabrication system UI 240 may be implemented to present a graphical representation 242 of configuration and/or fabrication information.

In various embodiments, the configuration and/or fabrication system UI 240 may be presented via a website. In certain embodiments, the website may be provided by the product configuration system 250. For the purposes of this disclosure a website may be defined as a collection of related web pages which are identified with a common domain name and is published on at least one web server. A website may be accessible via a public IP network or a private local network.

A web page is a document which is accessible via a browser which displays the web page via a display device of an information handling system. In various embodiments, the web page also includes the file which causes the document to be presented via the browser. In various embodiments, the web page may comprise a static web page, which is delivered exactly as stored and a dynamic web page, which is generated by a web application that is driven by software that enhances the web page via user input to a web server.

In certain embodiments, the user device 204 may be implemented to interact with the product configuration system 250, which in turn may be executing on a separate information handling system 200. In various embodiments, the product configuration system 250 interacts with a custom product fabrication system 252. In various embodiments, the custom product fabrication system 252 fabricates products. In various embodiments, the fabricated product includes a display device. In various embodiments, the display device includes a display device portrait mode optimization system.

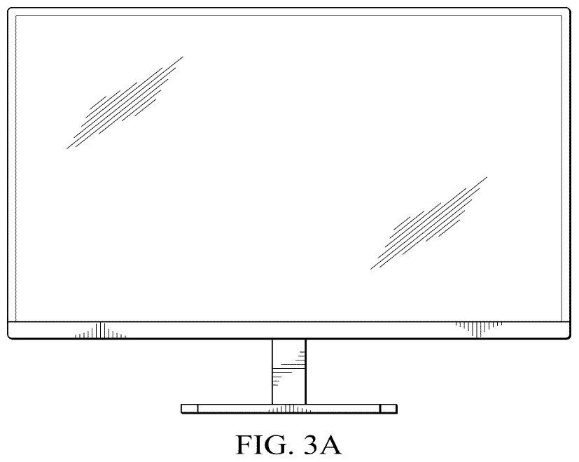

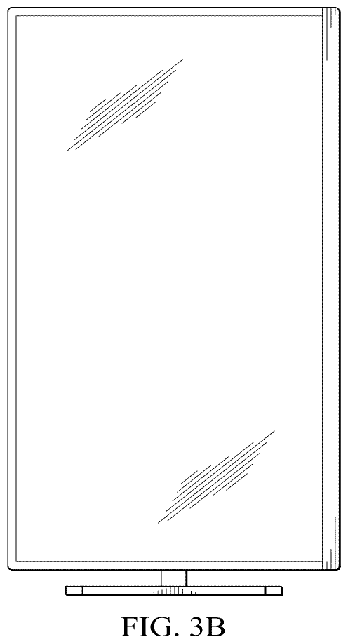

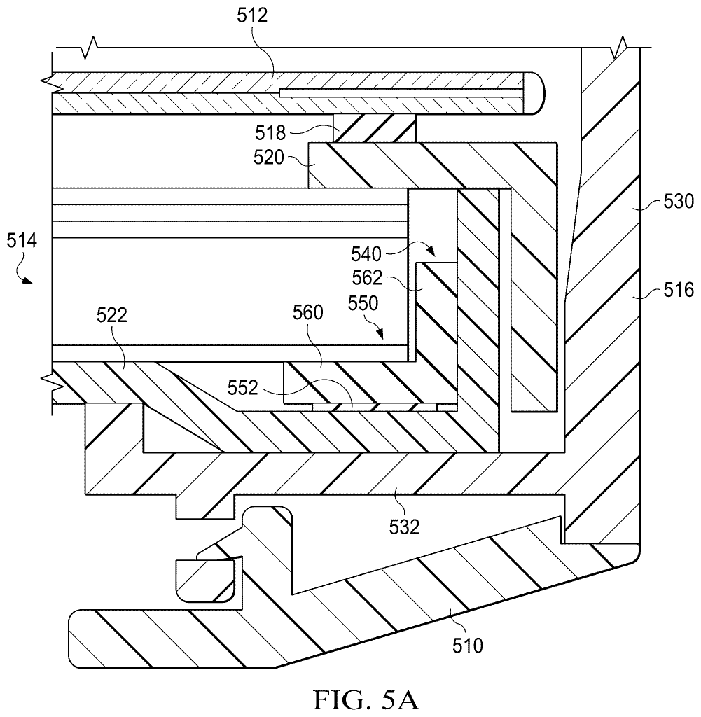

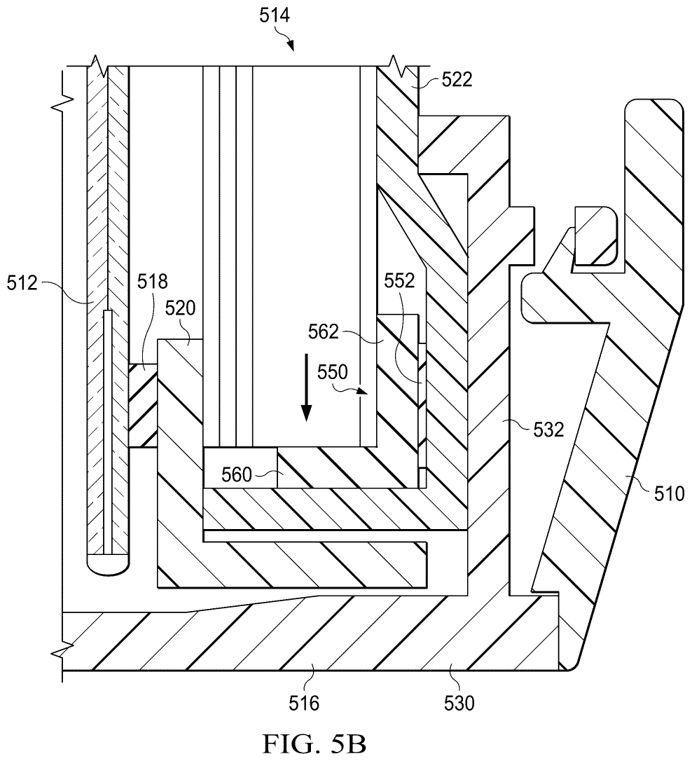

FIGS. 3A and 3B, generally referred to as FIG. 3, show front views of a display device 300 in a landscape orientation and a portrait orientation, respectively. More specifically, FIG. 3A shows a view of the display device 400 when the display device is operating in a landscape mode of operation. FIG. 5B shows a view of the display device 400 when the display device is operating in a portrait mode of operation. As used herein, a landscape mode of operation broadly refers to a presentation orientation of a display device in which the display presentation is wider than it is tall. With many display devices, the landscape mode of operation is the default mode of operation of the display device. Additionally, with many display devices, when operating in a landscape mode of operation the bottom edge of the display device is the edge via which much of the presentation of the display device screen is controlled. As used herein, a portrait mode of operation broadly refers to a presentation orientation of a display device in which the display presentation is taller than it is wide. With many display devices, when operating in a portrait mode of operation one of the side edges of the display device corresponds to the bottom edge of the display device when the display device is operating in a landscape mode of operation.

In various embodiments, the display device 300 includes a display device portrait mode optimization system. In certain embodiments, the display device portrait mode optimization system implements portrait mode optimized positioning device. In certain embodiments, the display device portrait mode optimization system performs a display device portrait mode optimization operation.

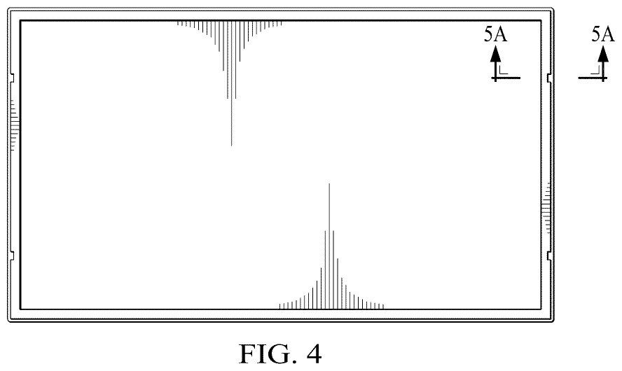

FIG. 4 shows a front view of a display device 400 which includes a panel design optimized for operation in landscape and portrait orientations. FIGS. 5A and 5B, generally referred to as FIG. 5, show views of section 5A when the display device is operating in a landscape orientation and a portrait orientation, respectively. More specifically, FIG. 5A shows a cut away view of a portion of the display device 400 when the display device is operating in a landscape mode of operation. FIG. 5B shows a cut away view of a portion of the display device 400 when the display device is operating in a portrait mode of operation.

In various embodiments, the display device 400 includes a display device portrait mode optimization system. In certain embodiments, the display device portrait mode optimization system implements a portrait mode optimized positioning device. In certain embodiments, the display device portrait mode optimization system performs a display device portrait mode optimization operation. In certain embodiments, the portrait mode optimized positioning device includes a reversible guide panel structure. In certain embodiments, the portrait mode optimized positioning device includes a guide panel which includes an embedded bumper structure. Various aspects of the present disclosure include an appreciation that providing a portrait mode optimized positioning device enables removal of the elastomeric components which optimizes display device portrait mode performance. Various aspects of the present disclosure include an appreciation that removal of the elastomeric components saves cost, reduces display device assembly complexity and reduces the likelihood of quality issues associated with mis-assembled elastomeric components.

Referring now to FIGS. 5A and 5B, the side portion of the display device 400 includes a rear frame portion 510, an open cell LCD component 512, an optical sheets component 514 a bottom cover system frame 516, a system frame mounting component 518, an edge cover 520 and a bottom cover 522. In certain embodiments, the open-cell LCD component 512 and the optical sheets component 514 are examples of display device optical components. In certain embodiments, the bottom cover system frame 516 includes an integrated mold frame. In certain embodiments, the bottom cover system frame 516 is configured to physically mate with the rear frame portion 510. In certain embodiments, the bottom cover system frame includes an exterior edge portion 530, an optical sheets support portion 532 and a bottom cover frame main housing portion 534. In certain embodiments, the bottom cover frame main housing portion 534 is positioned between the exterior edge portion and the optical sheets support portion.

In certain embodiments, the exterior edge portion 530 extends substantially (i.e., +/−20%) perpendicularly to the bottom cover frame main housing portion 534. In certain embodiments, the exterior edge portion 530 extends along a side edge of the outside of the display device 400. In certain embodiments, the exterior edge portion 530 includes an edge which functions as an outside bezel for the display device. In certain embodiments, the outside bezel is configured as a narrow bezel. In certain embodiments, the optical sheets support portion 532 extends substantially (i.e., +/−20%) perpendicularly to the bottom cover frame main housing portion 534. In certain embodiments, the optical sheets support portion 532 extends along a side edge of the inside of display device 400. In certain embodiments, the optical sheets support portion 532 is contiguous with an edge of the optical sheets component 514. In certain embodiments, the optical sheets support portion physically supports a portion of the optical sheets component 514. In certain embodiments, the optical sheets support portion 532 is configured to extend along one or both sides of the rectangular display device portion 410.

In various embodiments, the display device 400 includes a display device portrait mode optimization system 540. In certain embodiments, the display device portrait mode optimization system is positioned contiguous to a display device optical component. In certain embodiments, the display device portrait mode optimization system 540 implements a portrait mode optimized positioning device 550 and a positioning device attachment mechanism 552. In certain embodiments, the positioning device attachment device 552 physically couples the portrait mode optimized positioning device to an inside edge of the bottom cover 522. In certain embodiments, the display device portrait mode optimization system 540 performs a display device portrait mode optimization operation.

In certain embodiments, the portrait mode optimized positioning device 550 is implemented as a reversible guide panel structure. In certain embodiments, the reversible guide panel structure is substantially (i.e., +/−20%) “L” shaped. In certain embodiments, the reversible guide panel structure includes first portion 560 and a second portion 562 positioned substantially (i.e., +/−20%) perpendicularly with each other. In certain embodiments, the first portion 560 is positioned in a horizontal orientation and the second portion 562 is positioned in a vertical orientation when the display device is configured in a landscape mode of operation. In certain embodiments, the first portion 560 is pivoted to a vertical orientation and the second portion 562 is pivoted to a horizontal orientation when the display device is configured in a portrait mode of operation. In certain embodiments, the second portion 562 is longer than the first portion 560 is tall. In certain embodiments, the second portion is substantially (i.e., +/−20%) 25% longer than the first portion is tall. In certain embodiments, the second portion 562 is physically coupled to the bottom cover via the positioning device attachment device 552.

As shown in FIG. 5B, the reversible guide panel structure rotates substantially (i.e., +/−20%) 90 degrees when the display device is rotated from a landscape mode of operation to a portrait mode of operation.

Various aspects of the present disclosure include an appreciation that providing a portrait mode optimized positioning device 550 enables removal of the elastomeric components which optimizes display device portrait mode performance. Various aspects of the present disclosure include an appreciation that removal of the elastomeric components saves cost, reduces display device assembly complexity and reduces the likelihood of quality issues associated with mis-assembled elastomeric components.

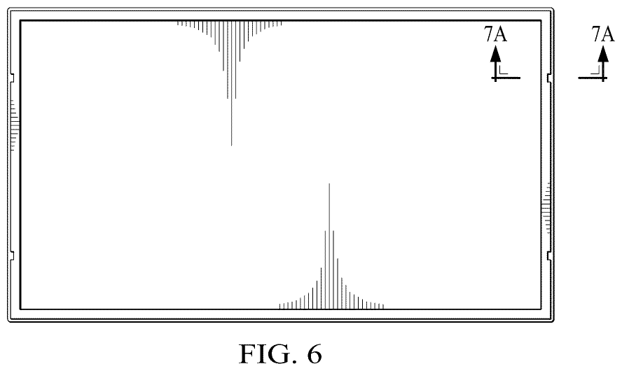

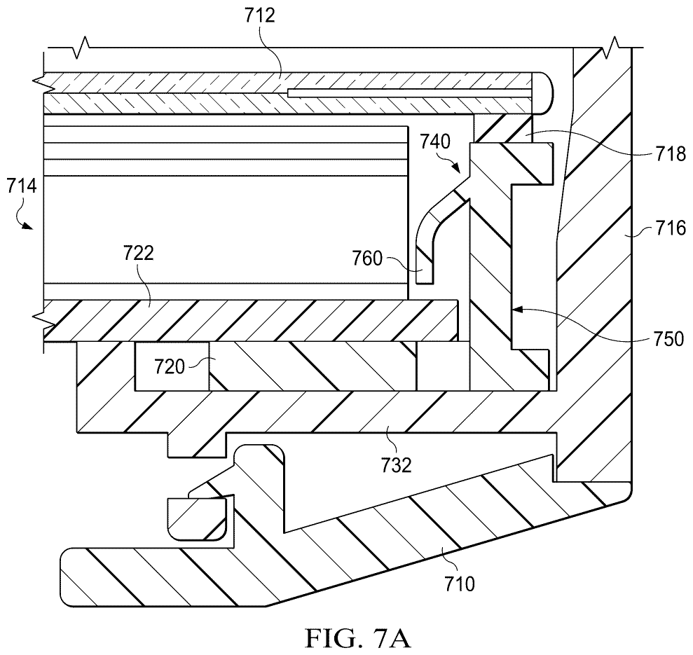

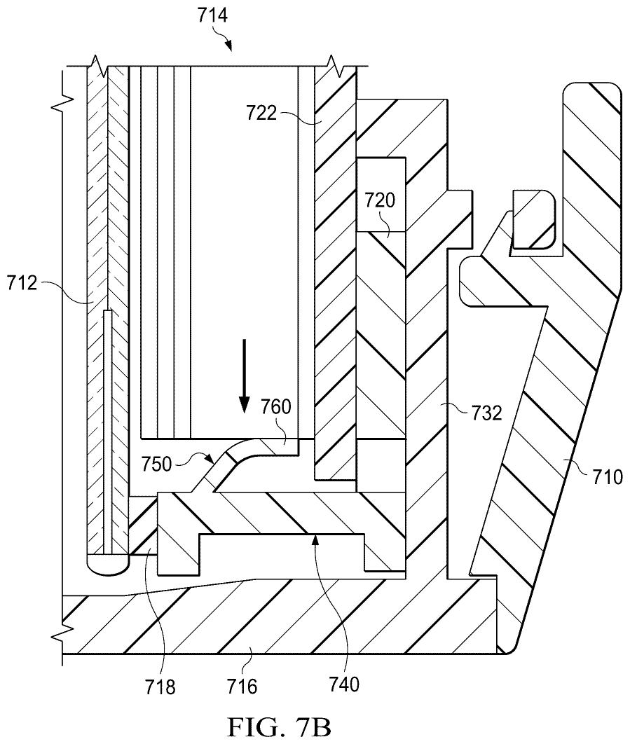

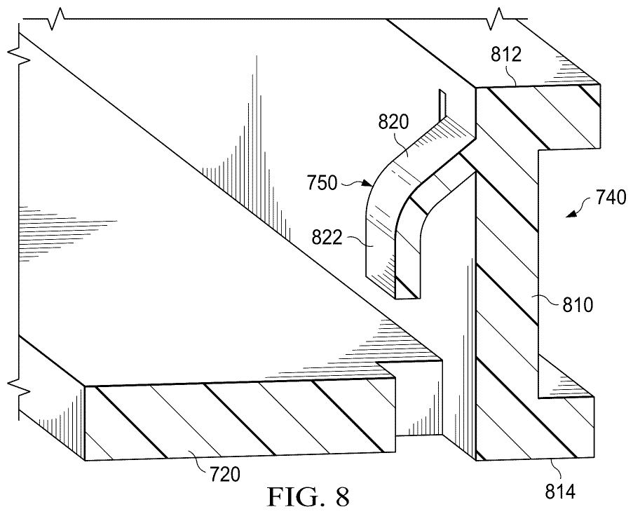

FIG. 6 shows a front view of a display device which includes a panel design optimized for operation in landscape and portrait orientations. FIGS. 7A and 7B, generally referred to as FIG. 7, show views of section 7A when the display device is operating in a landscape orientation and a portrait orientation, respectively. FIG. 8 shows a perspective view of a portion of a guide panel of a display device which is optimized for operation in landscape and portrait orientations.

In various embodiments, the display device 600 includes a display device portrait mode optimization system. In certain embodiments, the display device portrait mode optimization system implements portrait mode optimized positioning device. In certain embodiments, the display device portrait mode optimization system performs a display device portrait mode optimization operation.

Referring now to FIGS. 7A and 7B, the side portion of the display device 600 includes a rear frame portion 710, an open cell LCD component 712, an optical sheets component 714 a bottom cover system frame 716, a system frame mounting component 718, an edge cover 720 and a bottom cover 722. In certain embodiments, the open-cell LCD component 712 and the optical sheets component 714 are examples of display device optical components. In certain embodiments, the bottom cover system frame 716 includes an integrated mold frame. In certain embodiments, the bottom cover system frame 716 is configured to physically mate with the rear frame portion 710. In certain embodiments, the bottom cover system frame includes an exterior edge portion 730, an optical sheets support portion 732 and a bottom cover frame main housing portion 734. In certain embodiments, the bottom cover frame main housing portion 734 is positioned between the exterior edge portion and the optical sheets support portion.

In certain embodiments, the exterior edge portion 730 extends substantially (i.e., +/−20%) perpendicularly to the bottom cover frame main housing portion 734. In certain embodiments, the exterior edge portion 730 extends along a side edge of the outside of the display device 600. In certain embodiments, the exterior edge portion 730 includes an edge which functions as an outside bezel for the display device. In certain embodiments, the outside bezel is configured as a narrow bezel. In certain embodiments, the optical sheets support portion 732 extends substantially (i.e., +/−20%) perpendicularly to the bottom cover frame main housing portion 734. In certain embodiments, the optical sheets support portion 732 extends along a side edge of the inside of display device 600. In certain embodiments, the optical sheets support portion 732 is contiguous with an edge of the optical sheets component 714. In certain embodiments, the optical sheets support portion physically supports a portion of the optical sheets component 714. In certain embodiments, the optical sheets support portion 732 is configured to extend along one or both sides of the rectangular display device portion 610.

In various embodiments, the display device 600 includes a display device portrait mode optimization system 740. In certain embodiments, the display device portrait mode optimization system 740 implements a portrait mode optimized positioning device 750. In certain embodiments, the display device portrait mode optimization system 740 performs a display device portrait mode optimization operation.

In certain embodiments, the portrait mode optimized positioning device 750 is implemented as a reversible guide panel structure. In certain embodiments, the portrait mode optimized positioning device includes a guide panel which includes an embedded bumper structure 760.

As shown in FIG. 7B, the reversible guide panel structure rotates substantially (i.e., +/−20%) 90 degrees when the display device is rotated from a landscape mode of operation to a portrait mode of operation.

Referring now to FIG. 8, the portrait mode optimized positioning device 750 includes a main housing portion 810, a top housing portion 812 and a bottom housing portion 814. The portrait mode optimized positioning device 750 also includes the embedded bumper structure 760. In certain embodiments, the embedded bumper structure 760 includes an angled portion 820 and a flat portion 822. In certain embodiments, the angled portion 820 is physically coupled to an interior edge of the main housing portion 810 of the portrait mode optimized positioning device 750. In certain embodiments, the flat portion 822 is configured to provide support to optical components of the display device when the display device is operating in a portrait mode of operation. In certain embodiments, the embedded bumper structure 760 is configured to provide an elastic function without needing to provide the display device with rubber holders.

Various aspects of the present disclosure include an appreciation that providing a portrait mode optimized positioning device enables removal of the elastomeric components which optimizes display device portrait mode performance. Various aspects of the present disclosure include an appreciation that removal of the elastomeric components saves cost, reduces display device assembly complexity and reduces the likelihood of quality issues associated with mis-assembled elastomeric components.

The present invention is well adapted to attain the advantages mentioned as well as others inherent therein. While the present invention has been depicted, described, and is defined by reference to particular embodiments of the invention, such references do not imply a limitation on the invention, and no such limitation is to be inferred. The invention is capable of considerable modification, alteration, and equivalents in form and function, as will occur to those ordinarily skilled in the pertinent arts. The depicted and described embodiments are examples only, and are not exhaustive of the scope of the invention.

Consequently, the invention is intended to be limited only by the spirit and scope of the appended claims, giving full cognizance to equivalents in all respects.

1. A portrait mode optimization system for a display device comprising:
a portrait mode optimized positioning device positioned contiguous to a display device optical component, the portrait mode optimized positioning device being configured to perform a display device portrait mode optimization operation, the portrait mode optimized positioning device being configured to rotate substantially 90 degrees from a landscape mode of operation to a portrait mode of operation, the portrait mode optimized positioning device being positioned along a bottom edge of the display device when the display device is in the portrait mode of operation such that the display device optical component rests against the portrait mode optimized positioning device when the display device is in the portrait mode of operation; and,
a positioning device attachment device, the positioning device attachment device being configured to physically couple the portrait mode optimized positioning device to a bottom cover of the display device.

2. The portrait mode optimization system of claim 1, wherein:
the portrait mode optimized positioning device comprises a reversible guide panel structure.

3. The portrait mode optimization system of claim 2, wherein:
the reversible guide panel structure comprises a first portion and a second portion, the first portion and the second portion being positioned substantially perpendicularly with each other; and,
the second portion is physically coupled to the bottom cover of the display device via the positioning device attachment device.

4-6. (canceled)

7. A display device comprising:
a display device optical component; and,
a portrait mode optimization system, the portrait mode optimization system comprising
a portrait mode optimized positioning device positioned contiguous to the display device optical component, the portrait mode optimized positioning device being configured to perform a display device portrait mode optimization operation a component, the portrait mode optimized positioning device being configured to rotate substantially 90 degrees from a landscape mode of operation to a portrait mode of operation, the portrait mode optimized positioning device being positioned along a bottom edge of the display device when the display device is in the portrait mode of operation such that the display device optical component rests against the portrait mode optimized positioning device when the display device is in the portrait mode of operation; and,
a positioning device attachment device, the positioning device attachment device being configured to physically couple the portrait mode optimized positioning device to a bottom cover of the display device.

8. The display device of claim 7, wherein:
the portrait mode optimized positioning device comprises a reversible guide panel structure.

9. The display device of claim 8, wherein:
the reversible guide panel structure comprises a first portion and a second portion, the first portion and the second portion being positioned substantially perpendicularly with each other; and,
the second portion is physically coupled to the bottom cover of the display device via the positioning device attachment device.

10-12. (canceled)

13. A system comprising:
a processor;
a data bus coupled to the processor; and
a display device, the display device comprising
a display device optical component; and,
a portrait mode optimization system, the portrait mode optimization system comprising
a portrait mode optimized positioning device positioned contiguous to the display device optical component, the portrait mode optimized positioning device being configured to perform a display device portrait mode optimization operation, the portrait mode optimized positioning device being configured to rotate substantially 90 degrees from a landscape mode of operation to a portrait mode of operation, the portrait mode optimized positioning device being positioned along a bottom edge of the display device when the display device is in the portrait mode of operation such that the display device optical component rests against the portrait mode optimized positioning device when the display device is in the portrait mode of operation; and,
a positioning device attachment device, the positioning device attachment device being configured to physically couple the portrait mode optimized positioning device to a bottom cover of the display device.

14. The system of claim 13, wherein:
the portrait mode optimized positioning device comprises a reversible guide panel structure.

15. The system of claim 14, wherein:
the reversible guide panel structure comprises a first portion and a second portion, the first portion and the second portion being positioned substantially perpendicularly with each other; and,
the second portion is physically coupled to the bottom cover of the display device via the positioning device attachment device.

16-18. (canceled)
